(19) United States
(12) Patent Application Publication
(10) Pub. No.: US 2018/0193773 A1
(43) Pub. Date: Jul. 12, 2018

(54) BACKFLOW COLLECTION SYSTEM INCLUDING A CONVEYOR AND METHOD FOR RECLAIMING THE SAME

(71) Applicant: Granbury Thompson Group, LLC, Granbury, TX (US)

(72) Inventor: Bruce Thompson, Granbury, TX (US)

(21) Appl. No.: 15/917,199

(22) Filed: Mar. 9, 2018

Related U.S. Application Data
(63) Continuation-in-part of application No. 15/600,349, filed on May 19, 2017.
Application No. 15/600,349 is a continuation-in-part of application No. 15/424,005, filed on Feb. 3, 2017, now Pat. No. 9,687,761.
Application No. 15/424,005 is a continuation of application No. 13/735,879, filed on Jan. 7, 2013, now Pat. No. 9,597,614.
Application No. 13/735,879 is a continuation-in-part of application No. 12/685,549, filed on Jan. 11, 2010, now Pat. No. 8,449,779.
(60) Provisional application No. 62/470,138, filed on Mar. 10, 2017.
(60) Provisional application No. 62/338,862, filed on May 19, 2016.
(60) Provisional application No. 61/583,499, filed on Jan. 5, 2012.
(60) Provisional application No. 61/143,693, filed on Jan. 9, 2009.

(51) Int. Cl. B01D 21/24; E21B 43/34; E21B 21/06; B65G 33/26; B65G 33/10; B01D 21/00

(52) U.S. Cl. CPC B01D 21/245; E21B 43/34; E21B 21/065; E21B 21/063; B01D 21/0015; B65G 33/10; B01D 21/2461; B01D 21/2494; B01D 2221/04; B65G 33/265

(57) ABSTRACT

The disclosure provides a collection receptacle. In one embodiment, the collection receptacle includes an enclosure including a first portion and second portion configured to collect solid and liquid matter. The collection receptacle, in this embodiment, further includes a conveyor extending into the first portion of the enclosure and configured to remove the solid matter from the first portion, wherein the conveyor includes a first substantially horizontal portion and a second elevated portion, and further wherein a length of the first substantially horizontal portion is configured in such a way as to promote separation of the solid matter from the liquid matter as the solid matter travels up the conveyor and out of the enclosure.

### CROSS-REFERENCE TO RELATED APPLICATION

This Application claims the benefit of Provisional Application Ser. No. 62/470,138 entitled “CONVEY-X” to Bruce Thompson, filed on Mar. 10, 2017, and is a Continuation-in-Part of application Ser. No. 15/600,349, filed on May 19, 2017, entitled “BACKFLOW COLLECTION SYSTEM AND METHOD FOR RECLAIMING THE SAME” to Bruce Thompson, which is a Continuation-in-Part of application Ser. No. 15/424,005, filed on Feb. 3, 2017, entitled “BACKFLOW COLLECTION SYSTEM AND METHOD FOR RECLAIMING THE SAME” to Bruce Thompson, which is a continuation of U.S. application Ser. No. 13/735,879 filed on Jan. 7, 2013, entitled “BACKFLOW COLLECTION SYSTEM AND METHOD FOR RECLAIMING THE SAME,” which is a continuation-in-Part of U.S. application Ser. No. 12/685,549 filed on Jan. 11, 2010 entitled “BACKFLOW COLLECTION RECEPTACLE AND METHOD FOR RECLAIMING THE SAME” to Bruce Thompson which claims the benefit of Provisional Application Ser. No. 61/143,693 entitled “Gas Buster/Sand Auger” to Bruce Thompson, filed on Jan. 9, 2009. U.S. application Ser. No. 13/735,879 also claims benefit of Provisional Application Ser. No. 61/583,499 entitled “Oil Super Loop” by Bruce Thompson, filed on Jan. 5, 2012, all of which are commonly assigned with the present disclosure and incorporated herein by reference as if reproduced herein in its entirety.

### TECHNICAL FIELD

The present disclosure is directed, in general to a system and more specifically, to a backflow collection system and method for using the same.

### BACKGROUND

Production of oil and gas (e.g., hydrocarbons) from subterranean formations is dependent on many factors. These hydrocarbons must usually migrate through a low permeable formation matrix to drain into the wellbore. In many formations, the permeability is so low that it hinders the well's production rate and overall potential. In other wells, the near wellbore is damaged during drilling operations and such damage often results in less than desirable well productivity. Hydraulic fracturing is a process designed to enhance the productivity of oil and gas wells or to improve the infectivity of injection wells.

In the fracturing process, a viscous fluid is injected into the wellbore at such a rate and pressure as to induce a crack or fracture in the formation. Once the fracture is initiated, a propping agent, such as sand (e.g., often referred to as “frac” sand), is added to the fluid just prior to entering the wellbore. This sand laden slurry is continuously injected causing the fracture to propagate or extend. After the desired amount of proppant has been placed in the reservoir, pumping is terminated, and the well is shut-in for some period of time.

After the pressure is released from the wellbore, the sand, or at least a significant portion of the sand, remains within the fractured strata thereby holding the strata in a substantially fractured state. Accordingly, the oil and gas is allowed to flow freely. Unfortunately, as the oil and gas begin to flow it starts to push other unwanted fluids and gasses, as well as some unwanted particulates from the strata (including, frac sand, salts, etc.) back to the surface.

Simple frac tanks are commonly used to collect the unwanted fluid and particulates that backflow from the wellbore. A typical frac tank is configured as a large enclosure having a valve at the bottom thereof, often using a “gas buster” to dissipate the velocity of the backflow. When the frac tank is full of collected fluid, sand, salts, hydrocarbons, etc., an environmentally approved service must be employed to remove the contents thereof. A typical removal process initiates by removing the fluid from the frac tank via the valve at the bottom thereof. In this situation, as the sand is heavier than the other particles, the sand would be at the bottom of the tank. The fluid, hydrocarbons, salts, etc., most of which would be suspended in the fluid, would then be drawn through the sand and collected and disposed of. Unfortunately, the sand, in this removal scenario, becomes contaminated as the hydrocarbons and salts are drawn there through. Therefore, the sand must then be removed from the frac tank and processed so as to be safe for the environment. This process of collecting, removing, and decontaminating the backflow, including both the fluid and sand, is an extremely expensive process.

Accordingly, what is needed in the art is apparatus, and/or associated process, which reduces the time and expense associated with the collection and dispersal of the backflowed contaminants.

### SUMMARY

To address the above-discussed deficiencies of the prior art, the present disclosure provides a collection receptacle. The collection receptacle, in one embodiment, includes an enclosure including a first portion and second portion configured to collect solid and liquid matter. The collection receptacle, in this embodiment, further includes a conveyor extending into the first portion of the enclosure and configured to remove the solid matter from the first portion, wherein the conveyor includes a first substantially horizontal portion and a second elevated portion, and further wherein a length of the first substantially horizontal portion is configured in such a way as to promote separation of the solid matter from the liquid matter as the solid matter travels up the conveyor and out of the enclosure.

### BRIEF DESCRIPTION OF THE DRAWINGS

For a more complete understanding of the present disclosure, reference is now made to the following descriptions taken in conjunction with the accompanying drawings, in which:

FIG. 1 illustrates a collection receptacle in accordance with the disclosure;

FIGS. 2A thru 2E illustrate various views of an elevated auger including a housing and a flighting;

FIG. 3 illustrates an alternative embodiment of an elevated auger;

FIG. 4 illustrates yet another alternative embodiment of an elevated auger;

FIGS. 5-7 illustrate various different views of a backflow collection system manufactured and operated in accordance with this disclosure;

FIGS. 8A thru 8D illustrate another embodiment of a backflow collection system and components thereof in accordance with this disclosure; and

FIGS. 9A and 9B illustrate an alternative embodiment of a collection receptacle in accordance with the disclosure.

### DETAILED DESCRIPTION

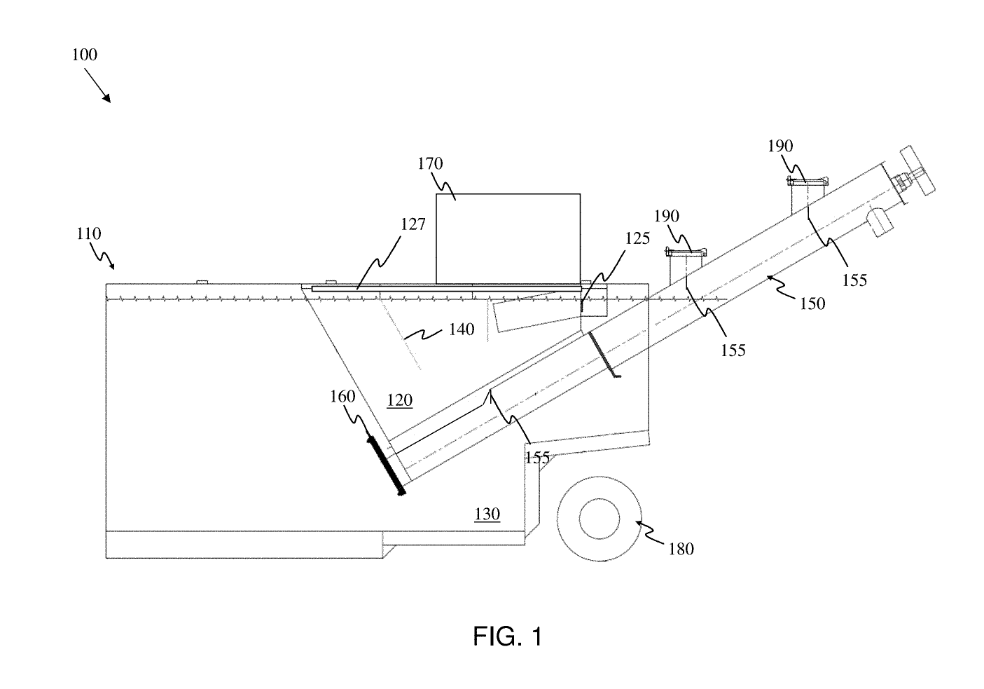

Referring initially to FIG. 1, illustrated is a collection receptacle 100 in accordance with the principles of the disclosure. The collection receptacle 100, as those skilled in the art appreciate, may be used to collect any number of different types of matter, including solid matter, liquid matter or a combination thereof. In one particular embodiment, the collection receptacle is configured to reclaim, including collecting and dispensing, backflow from a wellbore. For instance, the collection receptacle could be configured to reclaim fluid, hydrocarbons, frac sand, salts, etc., that would backflow from a wellbore after fracturing an oil and gas strata.

The collection receptacle 100 of FIG. 1 includes an enclosure 110. The enclosure 110, in this embodiment, is configured to collect solid and liquid matter. Moreover, the enclosure 110 of FIG. 1 includes a first portion 120 and a second portion 130. The first portion 120, in this embodiment, is configured to initially collect the solid and liquid matter. However, in this embodiment, the first portion 120 has an opening 125 (e.g., weir) in an upper region thereof. The opening 125, in one embodiment, is configured to allow excess collected liquid matter to overflow into the second portion 130 as the collected solid matter falls to a bottom of the first portion 120.

In one embodiment, the first portion additionally includes an emergency opening 127 configured to quickly divert extreme amounts of collected solid and liquid matter to the second portion 130. The purpose of the emergency opening 127, in this embodiment, is to prevent overflow of the collected liquid and/or solid matter from the enclosure 110 in the event the opening 125 cannot handle the volume of the incoming solid and liquid matter. As the emergency opening 127 is traditionally only used in extreme circumstances, the positioning of the emergency opening 127 is above the positioning of the opening 125. Accordingly, the emergency opening, in this embodiment, will only be employed in extreme circumstances. In the embodiment of FIG. 1, the opening 125 is located at the rear of the first portion 120, and the emergency opening 127 is located along the sides of the first portion 120. Nevertheless, the size, shape and location of each of the opening 125 and emergency opening 127 may be tailored on a use-by-use basis.

Located within the enclosure 110, and in this example the first portion 120, are one or more baffles 140. The baffles 140, in one example, are used to help direct the solid matter to the bottom of the first portion 120, among other uses.

The collection receptacle 100 further includes an elevated auger 150 extending into the enclosure 110, and more particularly the first portion 120 of the embodiment of FIG. 1. The auger 150, as would be expected, is configured to remove one or more contents from the enclosure 110. Nevertheless, in contrast to well known augers, the auger 150 is configured in such a way as to promote the separation of the solid matter from the liquid matter located within the enclosure 110, for example as the solid matter travels up the auger 150 and out of the enclosure 110. Specifically, the auger 150 of FIG. 1 includes a housing and a flighting, and in this embodiment the housing and flighting are configured in a manner to promote the aforementioned separation.

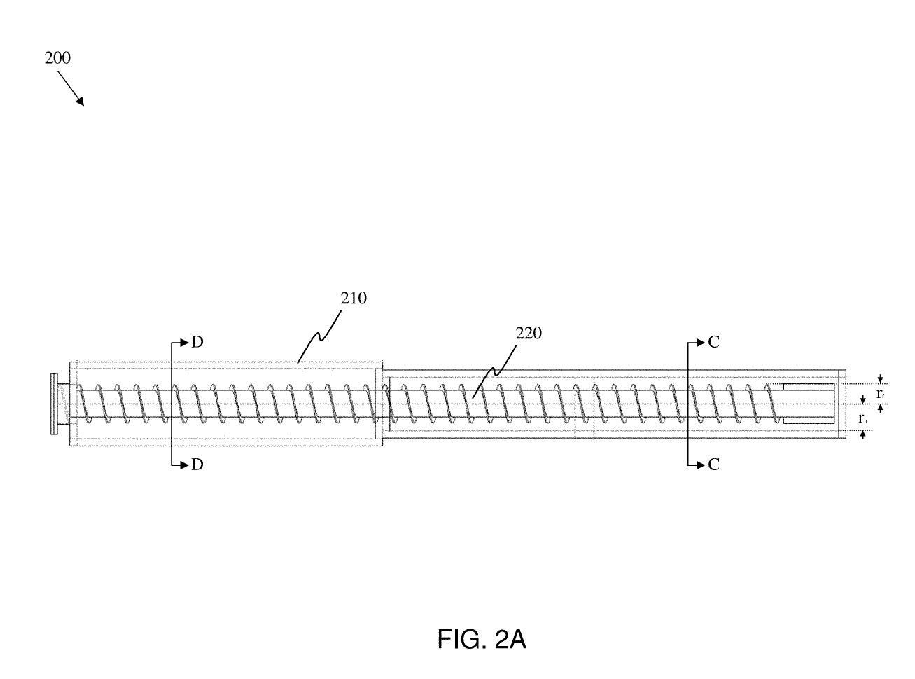

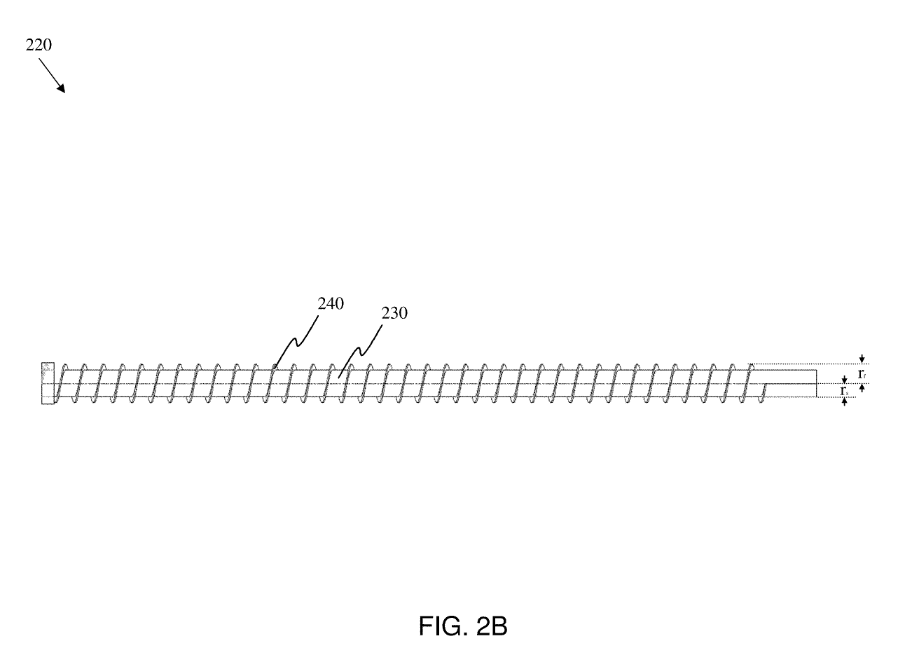

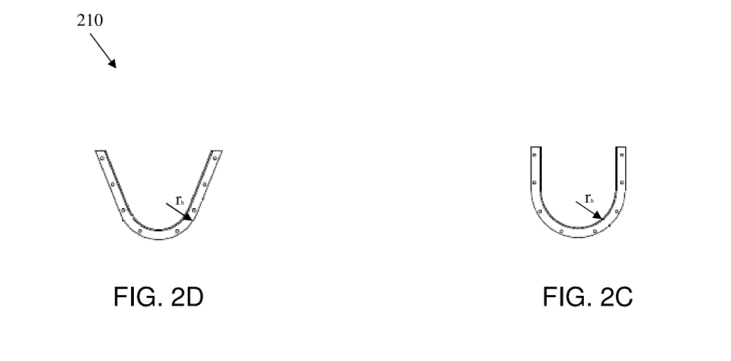

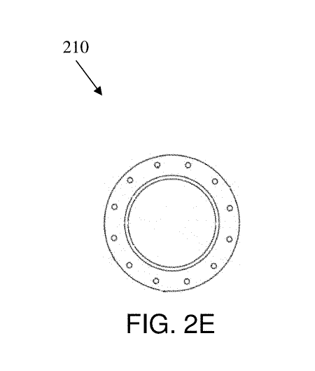

Turning briefly to FIGS. 2A thru 2D, illustrated are various views of an elevated auger 200 including a housing 210 and a flighting 220. FIG. 2A illustrates a cutaway view of the auger 200, whereas FIG. 2B illustrates the flighting 220, FIG. 2C illustrates a cross-section of the housing 210 taken through line C-C, and FIG. 2D illustrates a cross-section of the housing 210 taken through line D-D. In referring to the embodiment of FIGS. 2A thru 2D, the housing 210 has a radius rₕ and the flighting 220 has a lesser radius r_{f}, the difference in radius configured to promote separation of the solid matter from the liquid matter. Because of this lesser radius r_{f} of the flighting 220, the auger 200 creates a solid matter tube surrounding the flighting 220 as the solid matter is removed from the enclosure. The term solid matter tube, as used herein, is intended to reference a tube like feature using the solid matter itself as the tube, as opposed to other rigid materials such as steel, iron, etc. The solid matter tube, a sand or mud tube in one example, provides a porous means for the liquid matter to travel back down the auger 200 as the solid matter travels up the auger 200. Likewise, as the solid matter travels up the auger 200 it is squeezed by the pressure of the solid matter tube against the flighting 220, thus further promoting the separation of the liquid matter.

The degree of difference between the housing radius rₕ and the flighting radius r_{f} can be important to the ability of the auger 200 to promote separation. For instance, in one embodiment r_{f} is less than about 90 percent of rₕ. In yet another embodiment, r_{f} is less than about 75 percent of rₕ, and in yet another embodiment, r_{f} is less than about 67 percent of rₕ. For example, in the embodiment of FIGS. 2A thru 2D, r_{f} ranges from about 5 inches to about 7 inches, whereas rₕ ranges from about 8 to about 9 inches.

It has been acknowledged that certain configurations of the auger 150 experience issues with the solid matter tube caving in, or sliding back down to the bottom of the first portion 120. This is particularly evident when the spacing between the flighting and the housing are large. This is also particularly evident in the embodiment wherein the centerline of the housing and centerline of the flighting do not coincide. Based upon this acknowledgment, and substantial experimentation, it has been recognized that blocks 155 (FIG. 1) may be placed between the flighting and housing at various positioned along the length thereof. The blocks 155, in this embodiment, typically extend from the inside wall of the housing toward the flighting, and in doing so help reduce the likelihood of the solid matter tube caving in. The blocks 155, in one embodiment, typically extend from the upper most inner surface of the housing toward the flighting, are located at one to six different locations, and are not required between the lower most inner surface of the housing and the flighting. Other configurations, beyond those just disclose, might also be used.

Turning now specifically to FIG. 2B, illustrated is the flighting 220. The flighting 220, as shown, includes a radius r_{f}. Likewise, a shaft 230 of the flighting 220 includes a radius rₛ. To further promote the separation of the liquid matter from the solid matter, for example by way of increased pressing on the solid matter, the “teeth” 240 of the flighting 220 extend only a little way from the shaft. For example, in one embodiment, rₛ should be at least about 50 percent of r_{f}. In an alternative embodiment, rₛ should be at least about 65 percent of r_{f}, if not at least about 80 percent of r_{f}. For example, in the embodiment of FIG. 2B, rₛ ranges from about 3 inches to about 4 inches, whereas r_{f} ranges from about 5 inches to about 7 inches. To further promote separation, the teeth 240 may include notches therein, for example notches extending into the teeth 240 about 0.25 inches to about 1 inch.

Turning now specifically to FIGS. 2C and 2D, illustrated are the cross-sections of the housing 210. As is illustrated in FIG. 2C, this portion of the housing 210 has a u-shaped trough cross-section. In contrast, as is illustrated in FIG. 2D, this portion of the housing 210 has a flare-shaped trough cross-section. Nevertheless, other cross-sections could be used.

Turning briefly to FIG. 2E, illustrated is an alternative cross-sectional shape for the housing 210. In this embodiment, as shown, the housing 210 may have a circular cross-section. In this embodiment, the circular cross-section might have a radius ranging from about 8 to about 10 inches, and more particularly about 9 inches. As the radius of the flighting (r_{f}) is less than the radius of the circular cross-section of the housing 210, in this embodiment r_{f} ranging from about 5 to about 7 inches, a solid matter tube will likely form. It should be noted that in certain embodiments a centerline of the flighting will coincide with a centerline of the circular housing 210. In other embodiments, however, the centerlines will not coincide. For example, in one known embodiment the centerline of the flighting will be closer to a bottom surface of the housing 210 than an upper surface of the housing 210. In this embodiment, the distance between the flighting and the bottom surface of the housing 210 will be less than a distance between the flighting and the top surface of the housing 210.

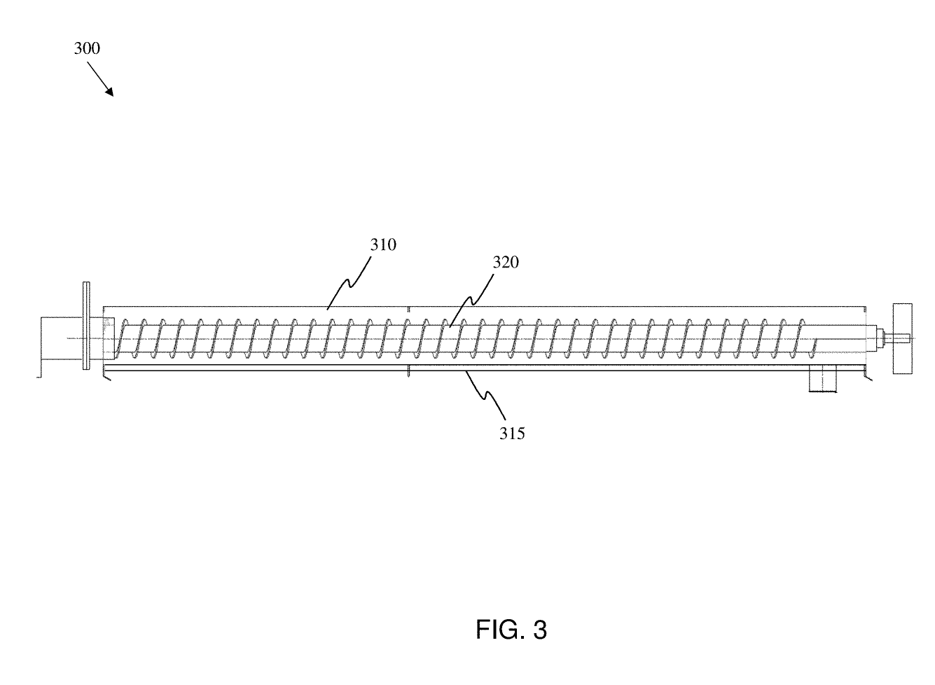

Turning now to FIG. 3, illustrated is an alternative embodiment of an elevated auger 300. The auger 300 of FIG. 3, in contrast to the degree of difference between the housing radius rₕ and the flighting radius r_{f}, includes a drain shoot 315 extending along a bottom surface of a housing 310 thereof. The drain shoot, regardless of the shape thereof, provides a pathway for excess fluid to travel back down the auger 300 as the solid matter travels up the auger 300. Accordingly, in this embodiment the housing 310 and the flighting 320 may have a somewhat similar overall shape and radius, but the added drain shoot 315 promotes the separation of the solid matter from the liquid matter. Accordingly, excess liquid matter squeezed from the solid matter travels down the drain shoot 315 as the solid matter travels up the auger 300.

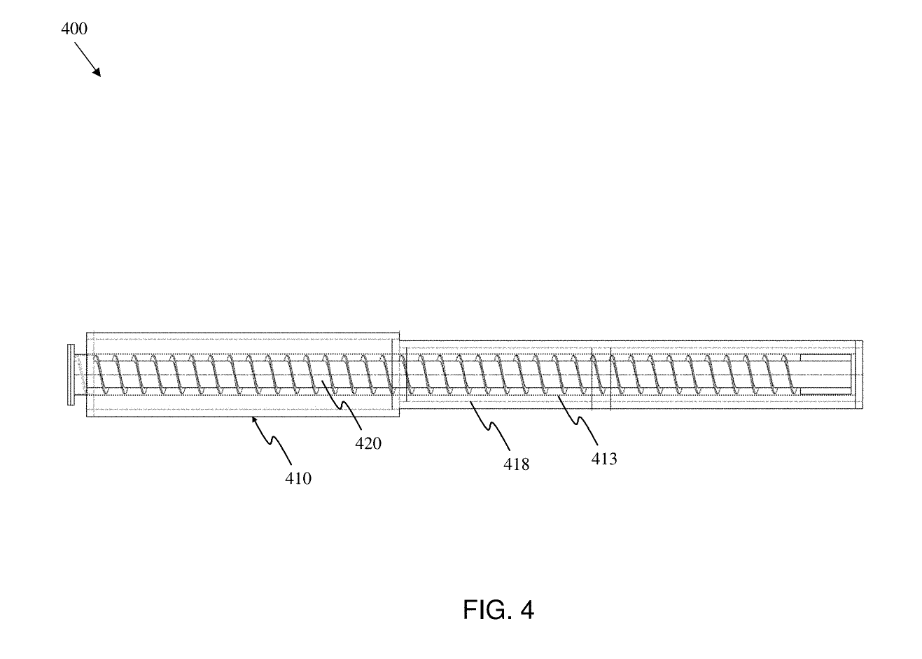

Turning now to FIG. 4, illustrated is an alternative embodiment of an elevated auger 400. The auger 400 of FIG. 4, in contrast to the degree of difference between the housing radius rₕ and the flighting radius r_{f}, includes a housing 410 having a first portion 413 and a second portion 418 and surrounding a flighting 420. In this embodiment, the first portion 413 is located between the second portion 418 and the flighting 420, and furthermore is perforated to promote the separation of the solid matter from the liquid matter. Accordingly, excess liquid matter squeezed from the solid matter exits the first portion 413 through the perforations therein, and then travels back down the auger 400 between the space separating the first and second portions 413, 418, respectfully.

Returning back to FIG. 1, the auger 150 includes a gate 160 at a bottom portion thereof. The gate 160, in this embodiment, is configured to allow solid matter to exit the auger 150 when operated in reverse. For example, certain situations may exist wherein solid matter remains within the enclosure 110, but there is a desire to fully empty the auger 150 of any solid matter. In this situation, the auger 150 could be operated in reverse, thereby emptying the auger 150 of any solid matter. The gate 160, in this example, allows the auger 150 to rid itself of solid matter without putting undue stress or torque on the auger 150 and/or its motor. Accordingly, the gate 160 may be opened when the auger 150 is run in reverse, and any solid matter within the auger 150 will be efficiently removed therefrom. In the embodiment shown, the solid matter exits into the second portion 130 of the enclosure 110.

The collection receptacle 100 of FIG. 1 further includes a gas buster 170 located between the enclosure 110 and a wellbore. The gas buster 170, as expected, is configured to dissipate energy associated with incoming solid and liquid matter. In the embodiment of FIG. 1, the gas buster 170 is coupled to an upper portion of the enclosure 110, for example near a rear thereof. The collection receptacle 100 of FIG. 1 further includes one or more wheels 180 coupled to the enclosure 110. The wheels 180 are configured to allow the collection receptacle 100 to roll from one location to another. Likewise, the auger 150 may include one or more inspection ports 190, for example with hinged covers,

A collection receptacle, such as the collection receptacle 100 of FIG. 1, may be used for reclaiming backflow from a wellbore. In one embodiment, solid and liquid matter originally enters the first portion 120 of the enclosure 110 through the gas buster 170. As the solid matter sinks to the bottom of the first portion 120, the liquid matter (e.g., the water, salts, and hydrocarbons) float to the top. As the solid and liquid matter continue to fill the first portion 120 of the enclosure 110, the liquid matter begins to flow through the opening 125 designed therein, to the second portion 130 of the enclosure 110. Once the solid matter approaches the top of the first portion 120 where the opening 125 exists, the first portion 120 will be substantially full of solid matter, while the second portion 130 of the enclosure 110 will primarily contain the liquid matter.

In certain embodiments, it is important that the revolutions per minute (rpm) of the flighting within the housing is slow enough to remove the solid matter from the enclosure, while allowing the liquid matter to be adequately removed there from. Accordingly, in direct contrast to traditional auger systems, the rpm of the flighting is intentionally kept slow. For example, in one embodiment the flighting has an rpm of about 15 or less. In other embodiments, an rpm of 12 or less provides advantageous results. In yet another embodiment, an rpm of 8 or less, and more particularly between about 4 and 8, provides superior results.

In this scenario, the liquid matter can be easily removed from the first portion 120 of the enclosure 110 without further contaminating the solid matter. The solid matter that exits the top of the auger 150 tends to be only slightly damp. Moreover, it is believed that this solid matter need not be decontaminated or reconditioned before being reused or introduced into the environment. Accordingly, the expense associated with this decontamination or reconditioning may be spared.

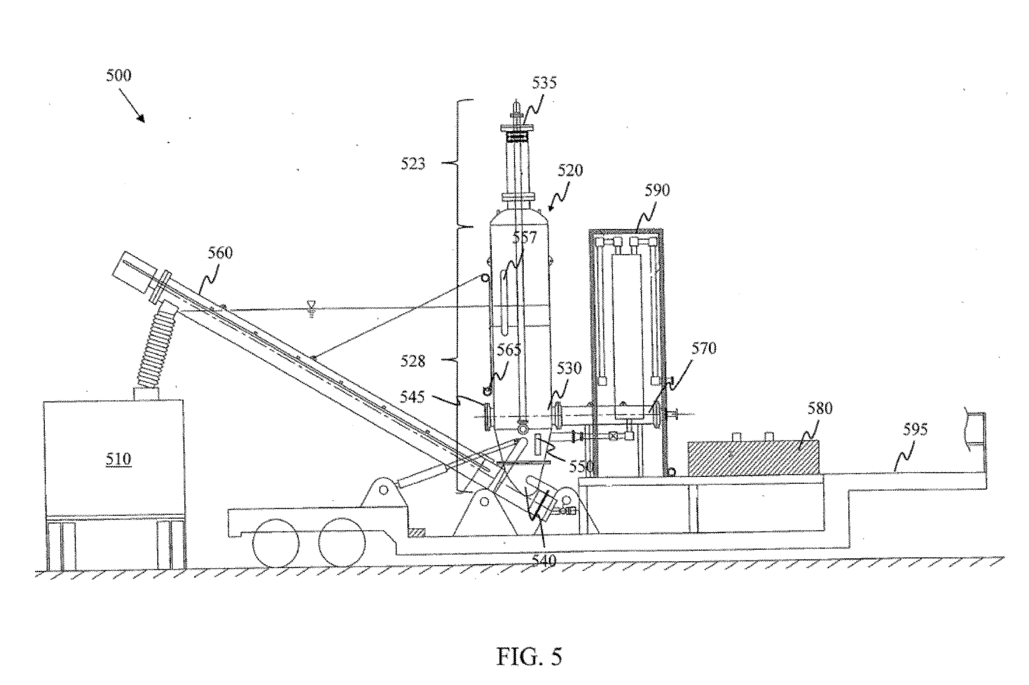

Turning to FIG. 5, illustrated is a backflow collection system 500 manufactured in accordance with the disclosure. The backflow collection system 500 includes a collection receptacle 510. The collection receptacle 510 is similar, in many ways to the collection receptacle 100 illustrated and discussed above. Accordingly, no further discussion is needed.

The backflow collection system 500 further includes a collection vessel 520 coupled to an auger 560. The collection vessel 520, in the illustrated embodiment, is configured as a vertical collection vessel. Such a configuration may be used to further help separate the solid and liquid matter from the gasses. The collection vessel 520, in one embodiment, includes an upper section 523 and a lower section 528. The lower section 528, in this embodiment, includes a side opening 530, while the upper section includes a discharge port 535. The side opening 530, in this embodiment, is configured to receive backflow from an oil/gas well. For example, the side opening 530 might comprise a pipe and flange configured to couple to an oil/gas well and receive backflow therefrom. The side opening 530 may be positioned at various different heights along the collection vessel 520. If the side opening 530 is positioned to near the bottom of the collection vessel 520, solid matter entering the collection vessel 520 may plug the side opening 530. In contrast, if the side opening 530 is positioned to near the top of the collection vessel 520, solid and liquid matter entering the collection vessel 520 may be pushed out the discharge port 535. The discharge port 535, in the illustrated embodiment, is configured to discharge pressurized gas received from the backflow from the oil/gas well from the collection vessel. One particular gas that may be discharged, and burned as it exits the discharge port 535, is hydrogen sulfide.

The auger 560, in the illustrated embodiment, is coupled proximate the lower section 528 of the collection vessel 520. The augur 560, in this embodiment, is configured to receive the solid and liquid matter from a bottom opening 540 in the lower section 528 of the collection vessel 520. When the auger 560 is elevated, and turned on, the auger 560 is configured to remove at least a portion of the solid and liquid matter from the collection vessel 520 while allowing the gasses to remain within the collection vessel 520, or alternatively exit the discharge port 535 in the upper end of the upper section 523 of the collection vessel 520. The auger may include a hoist 565, for example an electric hoist, to raise and lower the auger 560.

Bottom walls of the lower section 528 of collection vessel 520 may be slanted (e.g., from vertical) to assist the solid matter in exiting the bottom opening 540 into the auger 560. For example, the bottom walls of the lower section 528 might slant at an angle of at least about 45 degrees from vertical. In an alternative embodiment, bottom walls of the lower section 528 might slant at an angle of at least about 70 degrees from vertical.

A vibration mechanism 550 may be coupled to at least one of the collection vessel 520 or the auger 560. The term “vibration mechanism”, as used herein, encompasses any device capable of providing vibrations to the collection vessel 520 in such a way as to assist the solid material from exiting the collection vessel 520 and entering the auger 560. The vibration mechanism 550, in this embodiment, is configured to assist the auger 560 receive solid matter from the bottom opening 540 in the lower section 528 of the collection vessel 520. In the illustrated embodiment, the vibration mechanism 550 is coupled to the lower section 528 of the collection vessel 520. Nevertheless, the vibration mechanism 550 could also be coupled to the auger 560. Any type of vibration mechanism 550, including pneumatic and electric based vibration mechanisms, are within the scope of the present disclosure.

The collection vessel 520 further includes abrasion plate 545 located on an opposing side of the collection vessel 520 as the side opening 530. The abrasion plate 545 is configured to receive the brunt of the abrasion/force of the solid and liquid matter as it enters the collection vessel 520. The abrasion plate 545 is an additional feature added to a typical collection vessel. In one embodiment, the abrasion plate 545 is replaceable. For example, a second side opening could be included within the collection vessel, the second side opening directly opposing the side opening 530. In this embodiment, the abrasion place 545 could be attached to the second side opening. Accordingly, the abrasion place could be easily replaced when needed. The collection vessel 520 may additionally include a sight liquid level indicator 557.

The backflow collection system 500 may further include a gas buster 570. The gas buster 570, in this embodiment, is configured to reduce a velocity of the solid and liquid matter exiting the oil/gas well and entering the collection vessel 520. The gas buster 570, in the illustrated embodiment, couples directed to a flange associated with the side opening 530 in the collection vessel 520. Other embodiments exist wherein the gas buster 570 is not directly coupled to the collection vessel 520, but is located more near the oil/gas well.

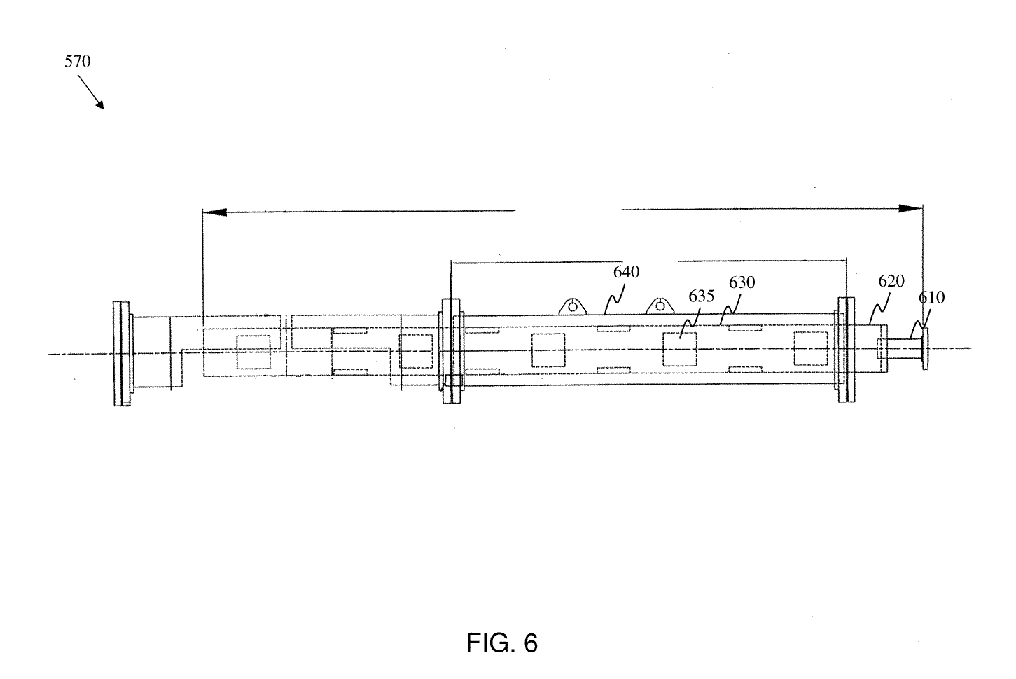

Turning briefly to FIG. 6, illustrated is an enlarged view of the gas buster 570 of FIG. 5. In the illustrated embodiment, the gas buster 570 includes a first section 610 and a second section 620. The first section 610, in this embodiment, includes a first cross-sectional area that is less than a second cross-sectional area of the second section 620. The increasing cross-sectional area of the gas buster 570 (e.g., as it approaches the collection vessel 520) is configured to reduce the velocity of the solid and liquid matter exiting the oil/gas well and entering the collection vessel 520. While the gas buster 570 only includes two steps in cross-sectional value, other embodiments may exist wherein three or more steps are used.

The gas buster 570, in the illustrated embodiment, further includes a first smaller pipe 630 that is encompassed by a second larger pipe 640. The first smaller pipe 630, in the illustrated embodiment, includes a plurality of openings 635 spaced along a length thereof. In fact, in the embodiment of FIG. 6, the openings 635 are sequentially spaced and rotated along the length of the first smaller pipe 630.

Returning to FIG. 5, the backflow collection system 500, in the illustrated embodiment, further includes a choke manifold 580 positioned between the side opening 530 in the collection vessel 520 and the oil/gas well. The choke manifold 580, in this embodiment, is configured to reduce a volume of the solid and liquid matter exiting the oil/gas well and entering the collection vessel 520. Those skilled in the art understand the various different choke manifolds 580 that might be used and remain within the purview of the present disclosure.

The backflow collection system 500, in the illustrated embodiment, may further include a high pressure sand trap 590 positioned between the side opening 530 in the collection vessel 520 and the oil/gas well. The high pressure sand trap 590, in this embodiment, is configured to remove a portion of the solid matter exiting the oil/gas well prior to entering the collection vessel 520. Those skilled in the art understand the various different high pressure sand traps 590 that might be used and remain within the purview of the present disclosure.

In the illustrated embodiment of FIG. 5, the collection vessel 520 and the auger 560 are position on a movable trailer 595. Further to the embodiment of FIG. 5, the gas buster 570, the choke manifold 580 and the high pressure sand trap 590 are also located on the movable trailer 595. In the illustrated embodiment, each of the collection vessel 520, auger 560, gas buster 570, choke manifold 580 and high pressure sand trap 590 are configured to transition from an operational positions to transit positions on the movable trailer.

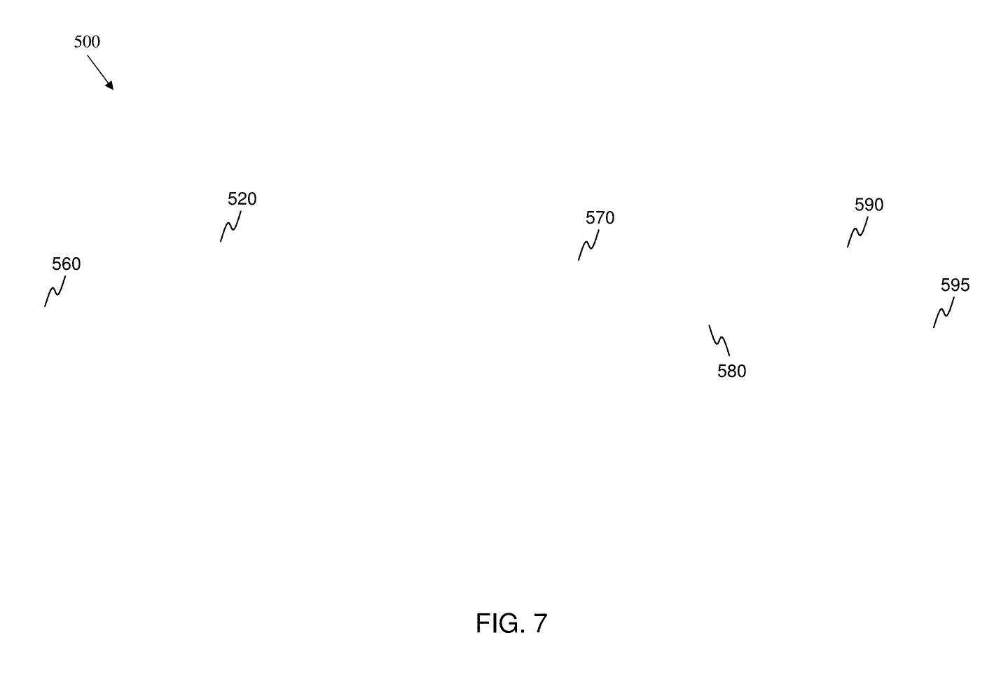

With brief reference to FIG. 7, illustrated are the collection vessel 520, auger 560, gas buster 570, choke manifold 580 and high pressure sand trap 590 in their transit positions. As illustrated, the collection vessel 520, auger 560, gas buster 570, choke manifold 580 and high pressure sand trap 590 may pivot to transition from the operational position to the transit position. Other mechanisms, however, could also be used to help the collection vessel 520, auger 560, gas buster 570, choke manifold 580 and high pressure sand trap 590 transition from the operational position to the transit position.

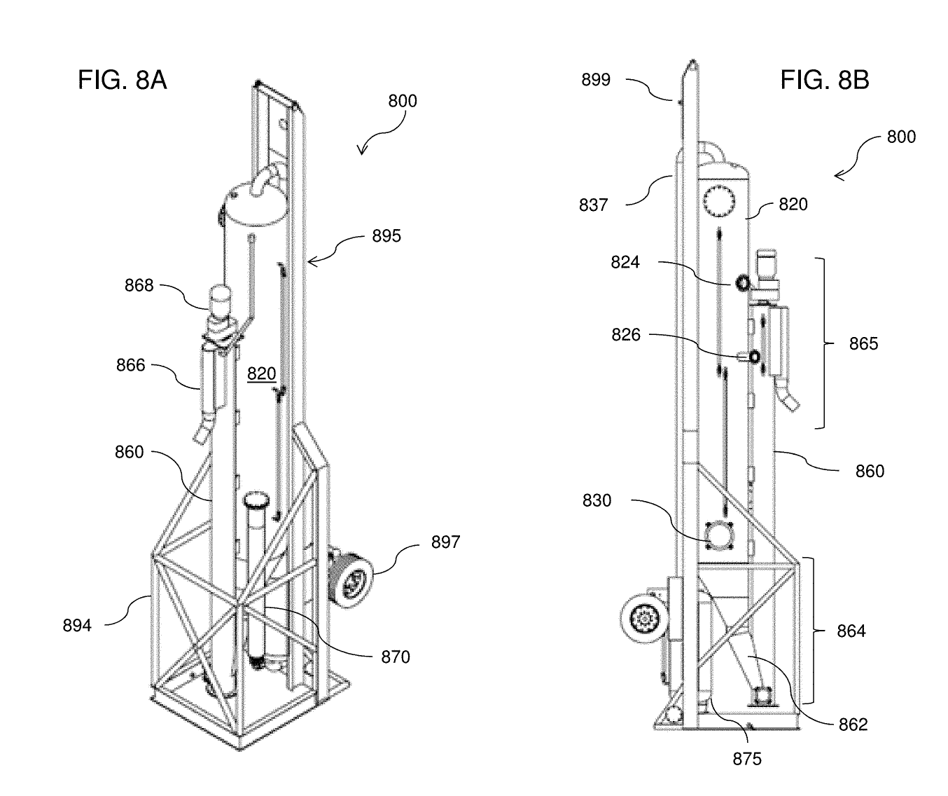

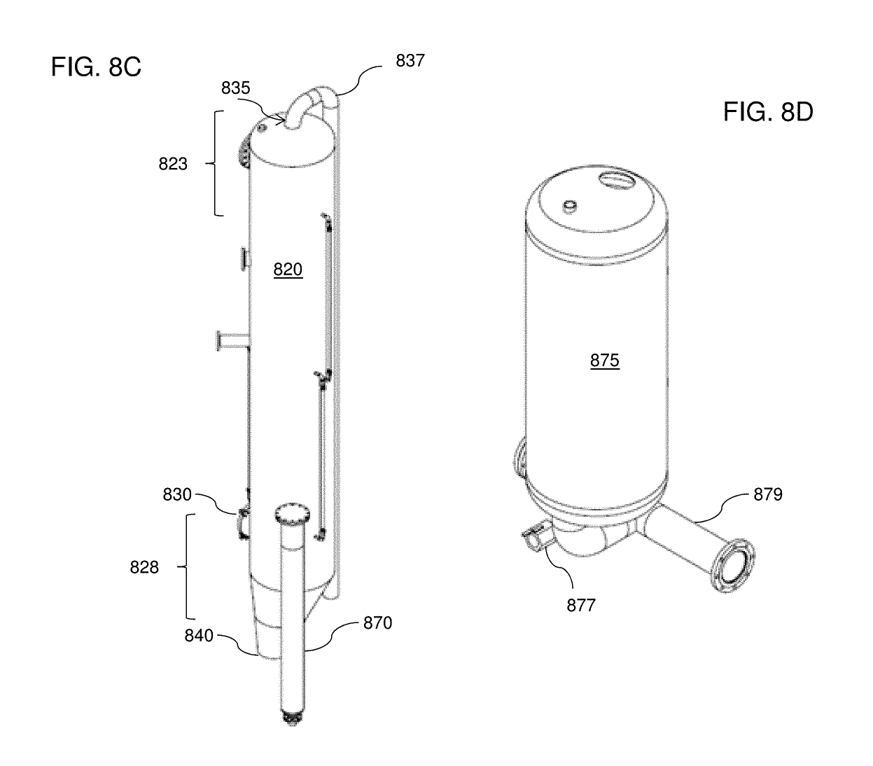

Referring now to FIGS. 8A-8D, there is shown another embodiment of a backflow collection system 800 in accordance with the disclosure. FIGS. 8A and 8B illustrate opposing sides of the backflow collection system 800. The backflow collection system 800 includes a substantially vertical auger 860 positioned adjacent to collection tank 820. The auger 860, in the illustrated embodiment, is coupled proximate a lower portion 828 of the collection tank 820 and is configured in a substantially vertical position adjacent the collection tank 820. Substantially vertical, as defined herein, means within +/−15° of 90° true vertical. In another embodiment, the auger 860 may be critically vertical, which means the auger 860 is positioned within +/−5° of true vertical.

Referring to FIG. 8C, there is shown the collection tank 820, having a gas buster 870 coupled adjacent thereto. Collection tank 820 is constructed similarly to collection vessel 520 as shown and described herein. The collection tank need not be a pressurized vessel, or even a standard vessel, but in certain embodiments it is. Similarly, gas buster 870 is constructed and functions similarly to gas buster 570 as shown and described in FIGS. 5 and 6, configured to dissipate energy associated with incoming solid and liquid matter. The collection tank 820 may be a vessel, receptacle, or container that may be used to collect liquids and gasses. In this embodiment the collection tank 820 is an enclosure and is configured in a substantially vertical position, wherein such a configuration may be used to further help separate the solid and liquid matter from the gasses.

The collection tank 820, in this embodiment, includes one or more side openings (e.g., one of which may be coupled to the gas buster 870) 830 and discharge port 835 near a top portion 823 of the collection tank 820. The side opening 830, in this embodiment, is configured to receive backflow from an oil/gas well, whether it be directly into the collection tank 820 via the side opening 830, or through the gas buster 870 coupled to the side opening 830. For example, the side opening 830 might comprise a pipe and flange configured to couple to an oil/gas well and receive backflow therefrom. In another embodiment, the side opening 830 might couple to the gas buster 870. The side opening 830 may be positioned at various different heights along the collection tank 820. If the side opening 830 is positioned near the bottom of the collection tank 820, solid matter entering the collection tank 820 may plug the side opening 830. In contrast, if the side opening 830 is positioned near the top of the collection tank 820, solid and liquid matter entering the collection tank 820 may be pushed out the discharge port 835. The discharge port 835, in the illustrated embodiment, is configured to discharge pressurized gas received from the backflow from the oil/gas well from the collection tank 820. One particular gas that may be discharged, is hydrogen sulfide, but other gas that may be recovered from an oil/gas well may be discharged as well. A flare line 837 may be coupled with discharge port 835 and run adjacent the collection tank 820 and connect with a knockout tank 875.

Referring briefly to FIG. 8D, there is shown knockout tank 875 which may be positioned near the bottom of collection tank 820. The knockout tank 875 may be coupled with and receive the discharged gas from the collection tank 820 via the flare line 837. The pressurized gas may be, in some embodiments, a liquid gas mixture that may be further processed to separate out any liquid or condensate. The knockout tank 875 is configured to separate any liquid remaining in the pressurized gas. Gravity causes the liquid to settle at the bottom of knockout tank and exit via an exit piping 877, while the gas may be discharged via discharge outlet 879. Removing the remaining liquid from the gas provides a more efficient burn off of the gas discharged from the flare line 537. A larger, potentially much longer, flare line might remove the gas away from the oil/gas drilling site for safe and efficient burn off.

Referring back to FIG. 8C, bottom walls of the lower section 828 of collection tank 820 may be slanted (e.g., from vertical) to assist the solid matter in exiting the bottom opening 840 into a receiver 862 of auger 860. For example, the bottom walls of the lower section 828 might slant at an angle of at least about 45 degrees from vertical. In an alternative embodiment, bottom walls of the lower section 828 might slant at an angle of at least about 70 degrees from vertical.

Referring back to FIG. 8B, in one embodiment, the collection tank 820 may comprise a manual float valve 824 for manual valve control of an overflow valve 826. If the liquid within the collection tank 820 gets higher than a static level within the collection tank 820, the float valve opens the overflow valve and discharges the excess sand and water directly in a collection tank such as collection receptacle 510 as shown in FIG. 5.

Referring back to FIGS. 8A and 8B, a vibration mechanism similar to vibration mechanism 550 may be coupled to at least one of the collection tank 820 or the auger 860. The vibration mechanism may operate and be configured similar to vibration mechanism 550 as described herein.

The auger 860, in this embodiment, is configured to receive solid and liquid matter from bottom opening 840 in a lower section 828 of the collection tank 820. When the auger 860 is elevated, and turned on, the auger 860 is configured to remove at least a portion of the solid and liquid matter from the collection tank 820 while allowing the gasses to remain within the collection tank 820, or alternatively exit the discharge port 835 near the top 823 of the collection tank 820. The auger 860 promotes separation of solid matter and liquid matter from the collection tank and thereafter deposits the separated solid and liquid matter into a SandX system, as described in U.S. Pat. No. 8,449,779. The separated solids and liquids may exit the auger 860 via an output 866 near a top portion 865 of auger 860.

The auger 860, in the illustrated embodiment, includes a variable frequency drive to modulate the speed of the flighting within the auger to tailor the amount of solid and liquid in the collection tank 820. Slowing the speed of the auger 860 creates resistance in the outflow of the fluids from the collection tank 820 and therefore adjusts the pressure in the collection tank 820. The variable frequency drive may be housed in gearbox 868 located proximate the top portion 865 of the auger 860.

The size of the flare line 837 may be tailored accordingly to adjust the flow of gas leaving the collection tank 820. In one embodiment, the flare line 837 may be sized as an 8″ flare line. For example, resistance in the flare line 837 may build ounces of pressure against the static pressure within the collection tank 820. The water in collection tank 820 creates a trap whereby the gas exits the collection tank 820 via the flare line 837. The amount of gas volume depends on the height of the water. As discussed previously, the use of a variable frequency drive to adjust the speed of the auger 860 likewise adjusts the pressure within the collection tank 820.

In one embodiment, the collection tank 820 vents to atmospheric pressure, which is approximately 1 atmosphere. In another embodiment, the collection tank 820 vents to the atmosphere. In this embodiment, the exiting gas would not add back pressure to the fluid or gas flow when exiting. According to another embodiment, the collection tank 820 operates below about 15 psi. Notwithstanding, other embodiments exist wherein the collection tank 820 operates above 15 psi.

The above, in combination with a supervisory control and data acquisition (SCADA) control system, provides real time feed forward and feedback information. Therefore, all of the parameters (e.g., pressure, fluid level, fluid in vs. fluid out, etc.) associated with the operation of the system can be used to tailor any other parameter, for example in real time. Additionally, the information obtained on the parameters may be logged and provided (e.g., potentially sold) as a value add. Via a wireless protocol, such as e.g., BLUETOOTH®, Wi-Fi, etc., users of the backflow collection system can follow, as well as engage and control, the backflow collection system from afar. The information may also be communicated via wired communication to local control system proximate the backflow collection system 800.

In one embodiment, the SCADA control system may be used to measure parameters within the backflow collection system 800, including at least a gas return flow rate, a fluid return flow rate, and a static level within the collection tank 820 using various meters and instrumentation. The gas flow return rate may be measured, in one embodiment, using a thermal dispensation meter. The fluid return flow rate may be measured using a radar positioned over a weir in a collection receptacle, such as, e.g., collection receptacle 510 in FIG. 5. The static level may be measured using a guided-wave radar.

An algorithm may be used to determine an operating speed of the auger 860 based on the parameters measured by the SCADA control system. The variable frequency drive of the auger 860 may thereafter adjust the speed of the flighting within the auger 860 according to the speed determined by the algorithm. In one embodiment, the parameters measured by the SCADA control system may be communicated to one or more blowout preventer valves within the gas well.

In the illustrated embodiment of FIG. 8A-8D, the collection tank 820, auger 860, gas buster 870, and knockout tank 875 are positioned within a frame 894 of a movable trailer 895. The movable trailer 895 includes wheels 897 and a vehicle connector 899 for connecting the trailer 895 with a vehicle for transport. For example, the trailer 895 may connect into a fifth wheel trailer connection or hitch of a truck or other similarly equipped heavy-duty vehicle. In the illustrated embodiment, each of the collection tank 820, auger 860, gas buster 870, and knockout tank 875 are configured to transition from a transit position, substantially horizontal, to a an operational position of substantially vertical, as shown in FIG. 8A, using a lift or hoist, such as, e.g. a hydraulic lift. In one embodiment, the movable trailer 895 may include a hydraulic lift whereby it can hydraulically lift itself into a substantially vertical operating position.

Although the backflow collection system is shown and described in FIGS. 8A thru 8D with only a single auger, in another embodiment, there may be a second adjacent to auger 860. The 2 augers may be configured as staggered or parallel relative to one another. A second auger further enables eliminating back pressure from building up inside collection tank 820. Each auger may be turned slower to prevent flexing on the auger housing (similar to housing 210 as discussed hereinabove). One or both augers may utilize a variable frequency drive to adjust the speed of the flighting within each auger. In yet another embodiment, there may be three or more augers. In an embodiment with multiple augers, a height of each auger may be shorter in height relative to an auger of a single auger system. The speed of one or more augers may be modulated differently for each auger as needed to tailor the flow rate of the backflow.

A backflow collection system, such as the backflow collection system of FIGS. 5-8, may be used to reclaim backflow from a wellbore and may be used with a SandX system, as is covered in U.S. Pat. No. 8,449,779. The backflow collection process may begin by collecting solid and liquid matter from the wellbore using the backflow collection system. As the solid and liquid matter, as well as the gasses, enter the collection tank, the auger may be operated in a manner to remove at least a portion of the solid and liquid matter from the collection tank, while at the same time the gas is allowed to exit the discharge port for burning.

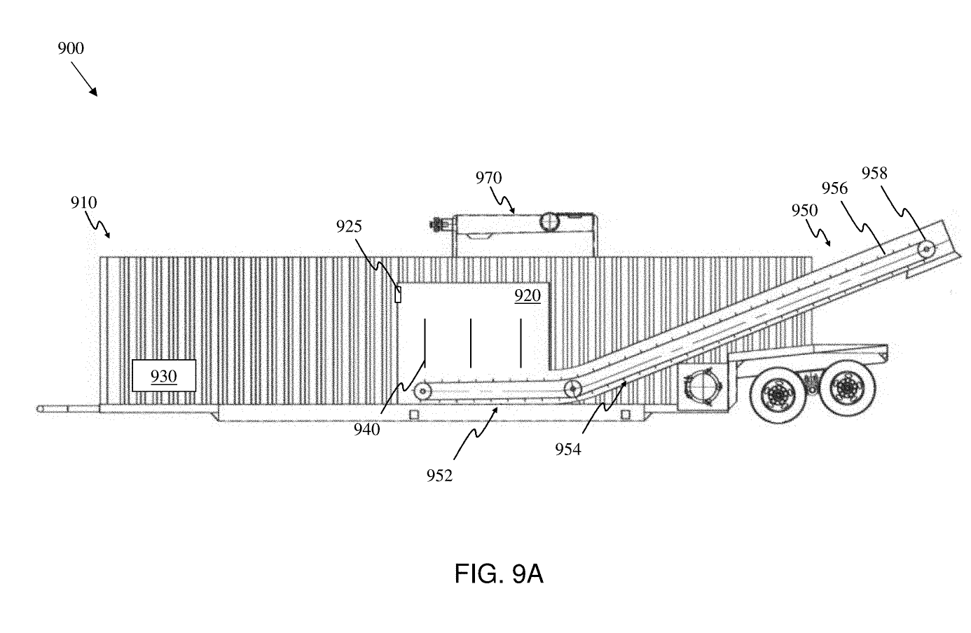

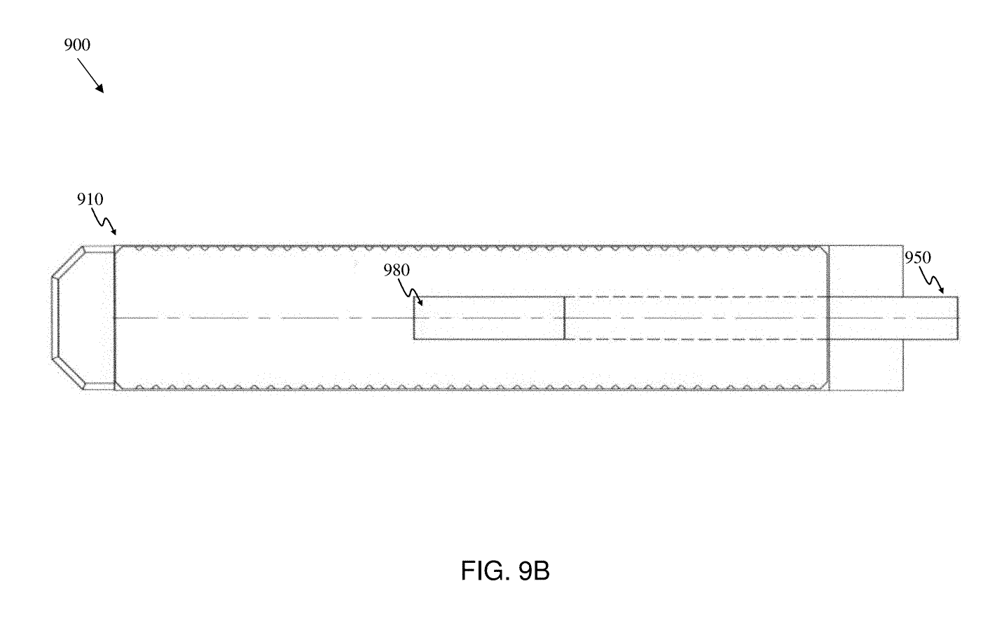

Turning now to FIG. 9A, illustrated is an alternative embodiment of a collection receptacle 900 manufactured in accordance with the principles of the disclosure. The collection receptacle 900 is similar in many respects to the collection receptacle 100 discussed and illustrated with regard to FIG. 1. Accordingly, the collection receptacle 900 may also be used to collect any number of different types of matter, including solid matter, liquid matter or a combination thereof.

The collection receptacle 900 of FIG. 1 includes an enclosure 110. The enclosure 110, in this embodiment, is configured to collect solid and liquid matter. Moreover, the enclosure 910 of FIG. 9 includes a first portion 920 and a second portion 930. The first portion 920, in this embodiment, is configured to initially collect the solid and liquid matter. However, in this embodiment, the first portion 920 has an opening 925 (e.g., weir) in an upper region thereof. The opening 925, in one embodiment, is configured to allow excess collected liquid matter to overflow into the second portion 930 as the collected solid matter falls to a bottom of the first portion 920.

Located within the enclosure 910, and in this example the first portion 920, are one or more baffles 940. The baffles 940, in one example, are used to help direct the solid matter to the bottom of the first portion 920, among other uses.

The collection receptacle 900 further includes an elevated conveyor 950 extending into the enclosure 910, and more particularly the first portion 920 of the embodiment of FIG. 9. The conveyor 950, in this embodiment, is configured to remove one or more contents from the enclosure 910. Nevertheless, in contrast to other systems, the conveyor 950 is configured in such a way as to promote the separation of the solid matter from the liquid matter located within the enclosure 910, for example as the solid matter travels up the conveyor 950 and out of the enclosure 910.

To accomplish such, in one embodiment the conveyor 950 includes a first portion 952 and a second portion 954. In the embodiment shown, the first portion 952 is substantially horizontal and the second portion 954 is elevated. In yet another embodiment, the first portion 952 is significantly horizontal and the second portion 954 is elevated, and in yet another embodiment the first portion 952 is ideally horizontal and the second portion 954 is elevated. The terms “substantially horizontal”, “significantly horizontal” and “ideally horizontal”, as used herein, mean that during operation the first portion is within about 20 degrees, about 10 degrees, and about 5 degrees, respectively, from perfectly level.

The second portion 954 may be elevated at a variety of different angles and remain within the purview of the disclosure. In one embodiment, the second portion 954 is elevated no more than about 45 degrees from horizontal. In yet another embodiment, the second portion 954 is elevated no more than about 30 degrees from horizontal, and in yet another embodiment the second portion 954 is elevated no more than about 20 degrees from horizontal. Moreover, certain embodiments exist wherein the angle of second portion 954 may be adjusted, and more particularly adjusted during operation in certain embodiments. The ability to adjust the angle of the second portion allows the conveyor 950 to be tailored based upon the circumstances by which it is operating.

The first and second portions 952, 954, and more importantly their lengths in relation to one another, may vary according to the design. In one embodiment, the length of first portion 952 is at least about 15 percent the length of the entire conveyor 950 (e.g., the first and second portions 952, 954 combined). In yet another embodiment, the length of first portion 952 is at least about 20 percent the length of the entire conveyor 950, and in even yet another embodiment, the length of first portion 952 is at least about 30 percent the length of the entire conveyor 950.

As is illustrated in the embodiment of FIG. 9, the conveyor employs a belt 956 and a plurality of spaced apart paddles 958. The paddles 958, and more importantly their pitch (e.g., spaced between adjacent paddles) and the height, may vary greatly to achieve superior solid material removal. In fact, contrary to what one skilled in the art might believe, a collection receptacle, such as the collection receptacle 900, often times benefits from greater distances between adjacent paddles and lesser heights for the paddles. For instance, such a configuration allows the liquid matter to separate from the solid matter much more easily as it travels up the second portion 954. Accordingly, in one embodiment the pitch of the paddles 958 is greater than about 16 inches. In yet another embodiment, the pitch of the paddles 958 is greater than about 24 inches, and in even yet another embodiment the pitch of the paddles 958 is greater than about 36 inches. In another embodiment, a height of the paddles 958 is less than about 8 inches. In yet another embodiment, the height of the paddles 958 is less than about 6 inches, and in even yet another embodiment, the height of the paddles 958 is less than about 4 inches. Certain combinations of the aforementioned disclosed pitch and height are within the scope of the present disclosure.

The conveyor 950, in accordance with the disclosure, may include a fixed frequency drive, or alternatively a variable frequency drive, for driving a speed of the belt 956. When employed, the variable frequency drive may be used to modulate the speed of the belt to tailor the amount of solid matter leaving the collection tank 920. Slowing the speed of the belt 956 creates time for the liquid matter to separate from the solid matter before it leaves the collection tank 920. The drive mechanism, whether it is a fixed drive or variable frequency drive, may be housed in gearbox located proximate a top portion of the conveyor 950.

The collection receptacle 900, in the illustrated embodiment, further includes a gas buster 970. The gas buster 970, in this embodiment, is located between the enclosure 910 and a wellbore. The gas buster 970, as expected, is configured to dissipate energy associated with incoming solid and liquid matter. In the embodiment of FIG. 9, the gas buster 970 is coupled to an upper portion of the enclosure 910, for example near a rear thereof.

Turning now to FIG. 9B, illustrated is a top down view of the collection receptacle 900 illustrated in FIG. 9A. As is illustrated, the collection receptacle 900, and more particularly the upper portion of the enclosure 910, include an opening 980 therein. The opening 980, in this embodiment, provides access to the first portion 920.

Although the present disclosure has been described in detail, those skilled in the art should understand that they can make various changes, substitutions and alterations herein without departing from the spirit and scope of the disclosure in its broadest form.

What is claimed is:

1. A collection receptacle, comprising:
an enclosure including a first portion and a second portion configured to collect solid and liquid matter; and
a conveyor extending into the first portion of the enclosure and configured to remove the solid matter from the first portion, wherein the conveyor includes a first substantially horizontal portion and a second elevated portion, and further wherein a length of the first substantially horizontal portion configured in such a way as to promote separation of the solid matter from the liquid matter as the solid matter travels up the conveyor and out of the enclosure.

2. The collection receptacle of claim 1, wherein the length of the first substantially horizontal portion is at least about 15 percent a length of the entire conveyor.

3. The collection receptacle of claim 1, wherein the length of the first substantially horizontal portion is at least about 20 percent a length of the entire conveyor.

4. The collection receptacle of claim 1, wherein the length of the first substantially horizontal portion is at least about 30 percent a length of the entire conveyor.

5. The collection receptacle of claim 1, wherein an angle of elevation of the second elevated portion is configured in such a way as to promote separation of the solid matter from the liquid matter as the solid matter travels up the auger and out of the enclosure.

6. The collection receptacle of claim 5, wherein the angle of elevation is no more than about 45 degrees from horizontal.

7. The collection receptacle of claim 5, wherein the angle of elevation is no more than about 30 degrees from horizontal.

8. The collection receptacle of claim 5, wherein the angle of elevation is no more than about 20 degrees from horizontal.

9. The collection receptacle of claim 1, wherein the angle of elevation is configured to be adjusted during operation.

10. The collection receptacle of claim 1, wherein the conveyor includes a belt and a plurality of spaced apart paddles.

11. The collection receptacle of claim 10, wherein a pitch of the paddles is greater than about 16 inches.

12. The collection receptacle of claim 10, wherein a pitch of the paddles is greater than about 24 inches.

13. The collection receptacle of claim 10, wherein a pitch of the paddles is greater than about 36 inches.

14. The collection receptacle of claim 10, wherein a height of the paddles is less than about 8 inches.

15. The collection receptacle of claim 10, wherein a height of the paddles is less than about 6 inches.

16. The collection receptacle of claim 10, wherein a height of the paddles is less than about 4 inches.

17. The collection receptacle of claim 10, wherein a fixed frequency drive system moves the belt.

18. The collection receptacle of claim 10, wherein a variable frequency drive system moves the belt.

19. The collection receptacle of claim 1, further including a gas buster positioned proximate an upper surface of the enclosure.

20. The collection receptacle of claim 1, wherein the enclosure and conveyor are positioned within a frame on a movable trailer.
